(19) United States
(12) Patent Application Publication
(10) Pub. No.: US 2020/0290002 A1
(43) Pub. Date: Sep. 17, 2020

(54) APPARATUS FOR GENERATING A GAS

(71) Applicant: COMMISSARIAT A L'ENERGIE ATOMIQUE ET AUX ENERGIES ALTERNATIVES, Paris (FR)

(72) Inventors: Michael BOUVIER, Varces Allieres et Risset (FR); Philippe CAPRON, Virieu sur Bourbe (FR); Jerome DELMAS, Merignac (FR); Vincent MATHIEU, Saint-Cassien (FR); Isabelle ROUGEAUX, Chabons (FR)

(73) Assignee: COMMISSARIAT A L'ENERGIE ATOMIQUE ET AUX ENERGIES ALTERNATIVES, Paris (FR)

(21) Appl. No.: 16/753,163

(22) PCT Filed: Oct. 18, 2018
(86) PCT No.: PCT/EP2018/078513

§ 371 Date: Apr. 2, 2020

(30) Foreign Application Priority Data
Oct. 18, 2017 (FR) 1759786

(51) Int. Cl. B01J 7/02; C01B 3/06; B01J 8/18

(52) U.S. Cl. CPC B01J 7/02; C01B 3/065; B01J 8/1809; C01B 2203/066; C01B 2203/1052; C01B 2203/107; B01J 2219/00227; B01J 2208/00539; B01J 2208/00716; B01J 2208/00893; B01J 2219/002; B01J 2219/00213; B01J 2208/00017

(57) ABSTRACT

Useful apparatus for generating a gas, comprising an enclosure defining an internal space for containing a liquid capable of generating the gas by coming into contact with a catalyst, a catalytic system comprising first and second parts that together define a catalysis chamber for containing the catalyst and that are movable relative to each other between a closed position, in which the catalysis chamber is isolated from the internal space, and an open position, in which the catalysis chamber is in fluid communication with the internal space, so that, when the liquid and the catalyst are respectively contained in the internal space and in the catalysis chamber, in the open position, the liquid enters the catalysis chamber and the gas is generated by bringing the liquid into contact with the catalyst, an actuator connected to the catalytic system and configured to place the catalytic system in the open position and/or in the closed position, and a command unit for commanding the actuator.

The present invention mainly relates to an apparatus for generating a gas, and in particular dihydrogen, by bringing a liquid into contact with a catalyst.

A well known method for generating dihydrogen involves bringing an aqueous hydride solution, for example, a sodium borohydride solution, into contact with a catalyst for the hydrolysis reaction of the hydride, which catalyst is made up of cobalt, platinum or ruthenium, for example. A hydrolysis reaction of the aqueous solution occurs through contact with the catalyst, generating dihydrogen.

By way of an example, WO 2012/003112 A1 and WO 2010/051557 A1 disclose apparatus for implementing such catalyzed hydrolysis of hydride. The gas generation apparatus disclosed in these documents comprise an enclosure containing, during operation, an aqueous hydride solution, and a catalytic system defining a catalysis chamber containing a catalyst for the hydrolysis of the aqueous hydride solution. The catalytic system comprises a body and a detachable cover. In the closed position of the catalytic system, the cover and the body together isolate the catalyst from the aqueous hydride solution. Therefore, no dihydrogen is generated. In the open position of the catalytic system, the cover is disposed at a distance from the body. The aqueous hydride solution then comes into contact with the catalyst, thus initiating the generation of dihydrogen. The dihydrogen thus generated is discharged out of the chamber through a discharge opening.

In order to prevent the pressure of the generated dihydrogen from being too high inside the enclosure, the catalytic system disclosed in WO 2012/003112 A1 and WO 2010/051557 A1 comprises an elastomer membrane in the form of a hollow cylindrical tube, fixed both on the body and on the cover. The body further comprises a drain emerging outside the enclosure at one of the ends thereof and in the internal space of the membrane at the opposite end thereof, so that the pressure in the internal space of the membrane is equal to the atmospheric pressure. Thus, when the dihydrogen pressure in the enclosure is greater than a threshold pressure, the cover is pushed against the body under the effect of the pressure in the enclosure, contracting the elastomer membrane through the effect of torsion, until the closed position of the catalytic system is reached. When the pressure in the enclosure is less than the threshold pressure, the elastomer membrane, attempting to regain its equilibrium position, deploys and releases the cover in the open position of the catalytic system, so as to allow the aqueous hydride solution to access the catalyst.

The exposure of the catalyst to the aqueous hydride solution is passively controlled in WO 2012/003112 A1 and WO 2010/051557 A1, i.e. the catalytic system is only opened and closed as a function of the dihydrogen pressure in the enclosure. The catalytic system disclosed in these two documents therefore offers little operating flexibility.

The catalytic system of WO 2012/003112 A1 and of WO 2010/051557 A1 has other disadvantages.

In order to ensure optimal contraction and deployment of the elastomer membrane, the height of the membrane must be low, which limits the access of the hydride based aqueous solution to the catalyst.

The threshold pressure for closing the catalytic system is determined by the stiffness of the elastomer membrane, which depends on the form and the mechanical properties, particularly the resilient properties, of the elastomer membrane. Therefore, it is difficult to design the membrane to ensure optimal operation of the apparatus.

Furthermore, it is not possible to control the opening and closing of the catalytic system independently of the pressure inside the enclosure.

Therefore, a requirement exists for a useful apparatus for generating a gas by bringing a liquid into contact with a catalyst that overcomes the aforementioned disadvantages.

This requirement is met by means of a useful apparatus for generating a gas, the apparatus comprising:
an enclosure defining an internal space for containing a liquid capable of generating the gas by coming into contact with a catalyst;
a catalytic system comprising first and second parts that together define a catalysis chamber for containing the catalyst;
the first and second parts being movable relative to each other, preferably by translation and/or by rotation, between a closed position, in which the catalysis chamber is isolated from the internal space, and an open position, in which the catalysis chamber is in fluid communication with the internal space,
   so that, when the liquid and the catalyst are respectively contained in the internal space and in the catalysis chamber, in the open position, the liquid enters the catalysis chamber and the gas is generated by bringing the liquid into contact with the catalyst; and
an actuator connected to the catalytic system and configured to place the catalytic system in the open position and/or in the closed position; and
a command unit for commanding the actuator.

As will become apparent in greater detail hereafter, the yield of dihydrogen generated by the apparatus according to the invention is increased compared to that generated by an apparatus as disclosed in WO 2012/003112 A1, for the same amounts of aqueous hydride solution and of catalyst and under identical experimental conditions.

The command unit is configured to transmit a command signal so as to directly or indirectly activate the actuator. As will become apparent hereafter, the transmission of the command signal can be independent of the pressure of the gas inside the enclosure. In other words, according to the invention, the gas generation can be stopped independently of the value of the pressure of the gas in the enclosure. In particular, in the closed position, with the catalysis chamber being isolated from the internal space, when the liquid and the catalyst are contained in the internal space and the catalysis chamber, respectively, the liquid cannot enter the catalysis chamber, with the impermeability of the catalysis chamber to the liquid being provided by the connection between the first and second parts. The apparatus according to the invention is thus operationally reliable.

The term “open position” is understood to be any position in which the catalysis chamber is in fluid communication with the internal space. The device can be placed in a plurality of open positions, which differ from one another through the distance and/or the angle separating the first and second parts. In particular, the catalytic device can be placed in first and second open positions that are different from one another, with the volume of the chamber accessible to the liquid in the first open position being different from the volume of the chamber accessible to the liquid in the second open position. In this way, the kinetics of gas generation by means of the apparatus can be modified by moving the catalytic device between two different open positions. In particular, the open position can be an extreme open position whereby the stroke of the actuator is reached.

The actuator is preferably fixed, for example, rigidly, to the catalytic system.

The actuator can be a ram, in particular a hydraulic ram or an electric ram or a pneumatic ram, or an electric motor.

Preferably, the actuator is a ram. A ram has the advantage of ease of application between the open and closed positions. Such a ram conventionally comprises a cylindrical body, in which a piston is housed that is able to move between a deployment position and a fallback position, by means of a translation and/or rotation movement, along or respectively around a parallel direction, in particular coincident with the axis of the cylinder. Preferably, when the ram is hydraulic or pneumatic, the ram further comprises a return component configured to exert a force on the piston that tends to return the piston to the fallback position.

Preferably, the cylindrical body of the ram is fixed on the first part and/or on the enclosure. The piston is preferably fixed on the second part.

Preferably, the ram is pneumatic. A pneumatic ram has the advantage of not requiring an electric power supply device to enable its operation. It particularly can be powered by means of a reserve of pressurized compressible fluid.

As a variant, the ram can be hydraulic. According to another variant, it can be electric.

However, the actuator is not limited to a ram. In one variant, the actuator can be a motor, in particular electric, for example, a stepper motor.

Preferably, in at least one of the open and closed positions of the catalytic system, at least one part of the ram is disposed in the catalysis chamber. Thus, any encroachment of the ram on the volume of the enclosure that is accessible to the liquid is limited.

Furthermore, the first and second parts can be translationally movable relative to each other between the open and closed positions, with the direction of translation being parallel to the longitudinal axis of the ram.

The apparatus can comprise a command valve connected to the command unit and to the ram, the command valve being configured to receive a command signal originating from the command unit and to deliver an amount of pressurized fluid to the ram and/or to purge the ram of said fluid, following the reception of said command signal.

In particular, in order to power the ram, the apparatus can comprise a pressurized fluid supply component connected to the command valve.

In one variant, the fluid is pneumatic, in particular gaseous, and the fluid supply component can be a cartridge having a tank, in which the pneumatic fluid is stored under pressure. Preferably, the cartridge is detachably connected to the command valve.

In another variant, the fluid supply component can be an assembly formed by a tank comprising the fluid, for example, at atmospheric pressure, connected to a compressor in the event that the fluid is gaseous, or to a pump in the event that the fluid is liquid, for example, an oil, in order to compress the fluid originating from the tank to a pressure that is greater than the atmospheric pressure. The compressor or the pump, if applicable, can be in fluid communication, for example, by means of a pipe, with the command valve, in order to convey the pressurized fluid through the command valve toward the actuator.

In one variant, in particular when the fluid supply component is the assembly as described in the preceding paragraph, the fluid supply component, the ram and the command valve define a closed circuit for the fluid. In other words, the fluid only flows from the fluid supply component to the ram through the command valve when pressurized fluid is supplied in the cylinder of the ram, and in the opposite direction when purging the ram.

The term “pressurized” fluid, in particular gaseous fluid, is understood to mean that the pressure of the fluid is greater than the atmospheric pressure. Preferably, the pressure of the fluid is greater than 1.1 bar, preferably greater than 1.5 bar, even greater than 2 bar. The “pressure” is defined relative to the zero pressure reference in the vacuum. The fluid can be a gas selected from air, carbon dioxide, argon, diazote or isobutane. Isobutane is preferred since it is liquefied at 20° C. at a pressure of 1.6 bar. The isobutane can be introduced into the tank under pressure, so that at least one part of the tank is filled with isobutane in liquid form. The isobutane in liquid form can transition to the gaseous phase when it is subjected to the atmospheric pressure. As a variant, the fluid can be a fluid, and in particular an oil.

Furthermore, the apparatus can comprise an electric power supply unit, for example, a battery. Preferably, the electric power supply unit is configured to deliver an electric power supply to the command unit. Furthermore, in particular as a function of the type of actuator, the electric power supply unit can be configured to supply electric power to other units and components of the apparatus.

In particular, in the variant whereby the actuator is a pneumatic or hydraulic ram, the electric power supply unit can be configured to deliver a power supply to the command valve and/or to the command unit in order to implement the opening and the closing of the command valve and to thus supply or respectively purge the ram. If applicable, it can be connected to the compressor or to the pump in order to electrically power them.

In the variant whereby the actuator is an electric ram or an electric motor, the electric power supply unit can be electrically connected to the actuator in order to implement the movement of the piston of the electric ram or the rotation of the motor.

With respect to the command unit, it is configured to transmit a command signal, so as to directly or indirectly command the actuator so that the actuator places the catalytic system in the open position or in the closed position.

The command unit can directly command the actuator. For example, the actuator is an electric motor and the command unit is directly electrically connected to the electric motor.

As a variant, the command unit can indirectly command the actuator. For example, the actuator is a ram and the command unit can send a command signal to the command valve, so that opening or closing the command valve leads to a movement of the ram.

Preferably, the command signal is an electric signal.

The command unit can be configured to command the actuator according to at least one control mode configured by means of at least one control parameter.

The control mode can be a regulation control mode, as will be described hereafter, or a specific control mode, different from the regulation control mode.

The command unit preferably comprises a processor adapted to execute a computer program, called control program, for implementing at least one control mode. The computer program can comprise instructions for reading and interpreting the control parameters.

The apparatus can comprise a storage module, for example, a computer hard drive or a flash memory, in which said control program and/or the control parameters can be stored.

As a variant, the apparatus can comprise a reader module configured to read a storage medium, for example, a USB stick or an SSD card, and the control program and/or the parameters of the control program can be stored in said storage medium. According to another variant, the reader module can comprise an input unit, for example, a keyboard or a touchscreen, adapted for inputting control parameters. In particular, the input unit can comprise a component for adjusting at least one control parameter, for example, in the form of a rotary button, with the angular position of the rotary button defining the value at which the control parameter is set.

The input unit can be configured so that the control parameter can be adjusted before and modified during the generation of the gas. Thus, when the control parameters are, for example, the minimum and maximum regulation pressures, as will be described hereafter, it is possible to modify said minimum and maximum regulation pressures in order to adapt the generated flow rate as a function of the gas requirements of the application for which the gas is generated by the apparatus.

The preferred control mode is a regulation control mode.

In particular, according to the regulation mode, the one or more control parameters preferably comprise at least one, preferably at least two, regulation parameters.

Preferably, the command unit is configured to undertake a comparison, called regulation comparison, of at least one quantity to be regulated with the at least one regulation parameter and is configured to send a command signal as a function of the result of the regulation comparison.

Preferably, the regulation mode is configured by means of control parameters comprising first and second regulation parameters and the command unit is configured to receive a quantity to be regulated and to command the actuator so as to place the catalytic system in a first position and in a second position, when the quantity to be regulated is less than the first regulation parameter and, respectively, greater than the second regulation parameter. The first and second positions can be open positions, preferably different from one another. According to a preferred variant, the first position is an open position and the second position is the closed position.

The quantity to be regulated can be selected from the gas pressure in the internal space, the gas pressure in a machine, preferably a fuel cell, with which the apparatus is in fluid communication, the generated gas flow rate and a temperature, for example, the temperature of the liquid or the temperature of the catalyst or the temperature of the environment of the apparatus.

Preferably, the quantity to be regulated is the gas pressure in the internal space, and the first and second regulation parameters are respectively minimum regulation pressures and maximum regulation pressures.

Preferably, the command unit is configured to send a command signal to the command valve, with a view to placing the catalytic system in a first position, respectively in a second position, when the gas pressure in the internal space is less than or equal to the minimum regulation pressure, respectively greater than or equal to the maximum regulation pressure. The first and second positions can be open positions. Preferably, the first and second positions are respectively an open position and a closed position.

The minimum regulation pressure and/or the maximum regulation pressure can be defined by the user of the apparatus. In particular, they can be determined as a function of the application for which the gas generation is intended. Advantageously, by modifying the minimum and/or maximum regulation pressures, the apparatus can generate gas at a constant setpoint flow rate and at a pressure that is adapted to the application for which the gas is intended.

As previously described, the command unit can be configured to execute at least one specific control mode different from the regulation mode.

In particular, according to at least one specific control mode, the command unit can be configured to hold the catalytic system in the open position and/or in the closed position for a holding duration. The holding duration is a control parameter of the specific control mode and is preferably independent of at least one, and in particular, of all the regulation parameters of the regulation mode.

For example, according to one variant, the specific control mode is a cold control mode, according to which the command unit is configured to:
optionally place the catalytic system in the open position during a first holding duration; then
place the catalytic system in the closed position during a second holding duration.

The first holding duration can be at least 10 times less than the second holding duration. For example, the first holding duration is 1 second, then the second holding duration is 60 seconds.

Furthermore, preferably, the apparatus comprises a control unit configured to:
receive at least one quantity to be controlled;
analyze the quantity to be controlled, in particular by comparing the quantity to be controlled with at least one control parameter; and depending on the result of the analysis,
generate a control signal according to the regulation mode or to a specific control mode different from the regulation mode; and
send the control signal to the command unit that is configured to receive said control signal and to execute the control mode corresponding to the control signal.

Preferably, the quantity to be controlled depends on the control mode to be executed by the command unit. In particular, the quantity to be controlled can be different for two different control modes. For example, according to the regulation mode, the quantity to be controlled can be the generated gas flow rate and/or the temperature in the chamber and, according to the cold control mode, the quantity to be controlled can be the generated gas pressure.

The quantity to be controlled can be selected from the gas pressure in the internal space, the gas pressure in a machine, preferably a fuel cell, with which the apparatus is in fluid communication, the generated gas flow rate and a temperature, for example, the temperature of the liquid or the temperature of the catalyst or the temperature of the environment of the apparatus.

Preferably, according to the regulation mode in which the quantity to be regulated is the gas pressure in the internal space, the control unit is configured to analyze, in particular jointly, the generated gas flow rate, the temperature of the liquid, the temperature of the catalyst and the temperature of the environment of the apparatus, preferably the flow rate and the temperature of the catalyst.

According to the regulation mode, the quantity to be controlled is preferably different from the quantity to be regulated.

Furthermore, the control unit preferably comprises a processor adapted to execute a computer program, called analysis program, for analyzing the quantity to be controlled with the at least one control parameter.

The analysis program and/or the analysis parameters can be stored in the storage module or read by the reader module as previously described, and the analysis program can comprise instructions for reading and interpreting the control parameters.

Preferably, the analysis of the quantity to be compared depends on the control mode executed by the command unit. In particular, the analysis program can comprise sets of instructions specific to at least one control mode.

In particular, the control unit can be configured to receive, over an analysis duration, for example, of less than 2 seconds, in particular 1 second, a plurality of values of the quantity to be controlled, and to formulate a result of the analysis after comparing each of the values of the quantity to be controlled with a control parameter. In particular, if the result of the control is that each value of the plurality of values is less than the control parameter, the control unit can transmit and send a control signal, according to a specific mode or according to the regulation mode, intended for the command unit.

For example, according to one example of the regulation mode, the control unit is configured to receive and to analyze two quantities to be controlled, namely the generated gas flow rate and the temperature of the catalyst, with the analysis being conducted by comparing each of said quantities to be controlled with a respective control parameter, respectively a setpoint flow rate and a setpoint temperature, throughout the analysis duration. Thus, if, during the analysis duration, the generated gas flow rate is less than the setpoint flow rate and/or the temperature of the catalyst is less than the setpoint temperature, the control unit is configured to send a control signal for cold control mode to the command unit.

Preferably, the control unit is configured to analyze, in particular jointly, at least two control quantities that are different from one another, for example, the generated gas flow rate and at least one temperature, for example, the temperature of the catalyst.

In the variant whereby the control mode is the regulation mode, the quantities to be controlled can be the temperature of the liquid and the gas pressure contained in the internal space and the control parameters can be a maximum temperature of the liquid and a maximum pressure of the gas.

In the variant whereby the control mode is the cold control mode, the quantities to be controlled can be the temperature of the catalyst and the gas pressure in the internal space and the control parameters can be a setpoint temperature of the catalyst and minimum and maximum setpoint pressures, for example, respectively equal to the minimum regulation pressure and to the maximum regulation pressure. The control unit can be configured to transmit a control signal, for example, in regulation mode, as soon as the temperature of the catalyst is greater than the setpoint temperature of the catalyst and as soon as the pressure of the gas in the enclosure is greater than the setpoint pressure.

As has been previously described, the command unit and the control unit are configured to respectively receive at least one quantity to be regulated and at least one quantity to be controlled.

Preferably, the apparatus comprises at least one unit for measuring a quantity selected from the gas pressure in the internal space, the gas pressure in a machine, preferably a fuel cell, with which the apparatus is in fluid communication, the generated gas flow rate and a temperature, for example, the temperature of the liquid or the temperature of the catalyst or the temperature of the environment of the apparatus. The measurement unit is also configured to send said measured quantity to the command unit and/or to the control unit. The measurement unit can be electrically connected to the command unit and/or to the control unit and it can be configured to send the measured value of the quantity in the form of an electric signal.

In one embodiment, the measurement unit is disposed in the internal space.

Preferably, the apparatus comprises at least two measurement units, which preferably are each configured to measure different quantities. In particular, the apparatus can comprise a unit for measuring the gas pressure in the internal space, a unit for measuring the generated gas flow rate, and at least one unit for measuring a temperature.

Depending on the control mode to be implemented by the command unit, the measured quantity can be a quantity to be controlled and/or a quantity to be regulated.

Furthermore, the apparatus can comprise a switching unit comprising a switch, for example, an electric switch, able to be placed in an on or off configuration by a user of the apparatus. The switching unit is configured to generate a switching signal and to send said switching signal to the command unit, which is configured to receive said signal, with a view to commanding the closure, respectively the opening, of the catalytic system, when the switch is placed in the off configuration, respectively in the on configuration.

The apparatus can comprise the control unit and the switching unit. Preferably, the command unit is configured to only process the switching signal, when the control unit and the command unit each jointly send a control signal and a switching signal to the command unit.

Furthermore, the apparatus can comprise an alarm unit, which is configured to transmit a signal, for example, an audible or light signal.

Preferably, the enclosure comprises a gas discharge opening. The apparatus preferably comprises a pressure measurement unit configured to measure the pressure of the gas. The pressure measurement unit preferably comprises a pressure sensor that can be disposed in the discharge opening. In one variant, the gas discharge opening can be sealed, or respectively open, for example, by means of a valve, preferably a flow control valve, so as to prevent, or respectively allow, gas to be discharged from the enclosure when the pressure of the gas in the enclosure is less than, or respectively greater than or equal to, a discharge pressure. For example, the discharge pressure can be greater than 4 bar. The command unit can be configured to command the opening and the closing of the valve. As a variant, the valve can be made of a resilient deformable material configured to prevent, or respectively allow, the fluid to be discharged from the enclosure when the fluid pressure is less than, or respectively greater than or equal to, the discharge pressure.

Preferably, the catalytic system is disposed in the internal space of the enclosure. The fluid communication of the catalytic system with the internal space of the enclosure is thus facilitated in the open position of the catalytic system.

Preferably, the catalytic system is fully immersed in the liquid. The generation of gas in the apparatus can be stopped in such a configuration, for example, after a command signal is sent to close the command valve, in particular when the pressure of the gas in the enclosure does not result in any compression force on the catalytic system.

In one embodiment, the apparatus comprises the catalyst. Preferably, the catalyst is a metal, preferably adapted to catalyze the hydrolysis of a hydride-based solution. A particularly preferred catalyst is selected from cobalt, nickel, platinum, ruthenium and the alloys thereof.

Furthermore, the apparatus can comprise the liquid contained in the internal space of the enclosure. Preferably, the liquid is an aqueous solution comprising a hydride as described hereafter.

Preferably, at least one portion of the catalyst is fixed on the first part and/or on the second part. In one embodiment, the catalyst is only fixed on the first part or only on the second part.

The catalyst can be disposed so as to be movable or to be fixed relative to the enclosure during the transition from the open position to the closed position.

Furthermore, the apparatus is designed so that, in the open position of the catalytic system, when the enclosure contains the liquid, more than 50%, preferably more than 80%, preferably more than 90%, even in particular the entire surface of the catalyst not in contact with the first part and/or with the second part is in contact with the liquid. This thus advantageously improves the kinetics of the reaction of the gas generation by bringing the liquid into contact with the catalyst.

Preferably, in order to facilitate the access of the liquid to the catalyst, the stroke of the piston of the ram is equal to or greater than the thickness of the catalyst, said thickness being measured in a direction parallel to the axis along which the piston is deployed.

The catalyst can be in different forms, in particular in the form of a coating, for example, deposited by chemical vapor deposition or by physical vapor deposition, disposed on a face of a wall of the first part and/or on a face of a wall of the second part that at least partially define the catalysis chamber. Preferably, the thickness of the coating is less than 1 mm. In the form of a coating, the ratio of the surface accessible to the liquid to the volume of the catalyst is optimal. Furthermore, such a form of the catalyst promotes the manufacture of a compact catalytic system, which, when it is disposed in the internal space of the enclosure, hardly encroaches on the volume accessible to liquid.

In one variant, the catalyst can be in the form of a block, having a thickness of more than 1 mm. For example, the block can be in the form of a patch or of a hollow rotationally cylindrical tube.

Preferably, the first part is fixed relative to the enclosure and the second part is movable relative to the enclosure between the open and closed positions. Preferably, the catalytic system, preferably the second part, is fixed, in particular rigidly, to the actuator. In particular, in the variant whereby the actuator is a ram, the second part is fixed, preferably rigidly, to the piston of the ram, preferably at the end of the piston that is disposed in an open position outside the cylindrical body of the ram.

The form of the first and second parts can vary. The first part can be in the form of a container for containing the catalyst. In particular, in the variant whereby the apparatus comprises the catalyst, the catalyst is, for example, disposed in the internal space of the container or it coats, for example, at least one, even all, the faces of the walls of the container that at least partially define the catalysis chamber. Preferably, the container comprises at least one opening, and the second part is in the form of a cover, for example, in the form of a plate, adapted to seal the opening of the container in the closed position.

In one variant, the first part is in the form of a plate. In particular, the plate can be covered with a coating formed by the catalyst. Then preferably, the second part preferably is in the form of a bell, so that in the closed position the second part rests on the first part and isolates the catalysis chamber from the internal space.

Preferably, irrespective of the form of the first and second parts, in order to provide the impermeability of the catalysis chamber to the liquid in the closed position, the first part and/or the second part can comprise a gasket seal, which in the closed position is sandwiched and compressed between the first and second parts. As a variant, the second part can be covered with a flexible material, or can be made up of a flexible material, in order to provide the seal in the closed position.

With respect to the catalysis chamber defined by the catalytic system, its volume is preferably greater than 1 ml.

In a particular embodiment of the invention, a wall of the first part, respectively of the second part, can comprise at least one window passing through the thickness of said wall, the window of the first part, respectively of the second part, being fully sealed by the second part, respectively by the first part, in the closed position of the catalytic system, and the windows of the first and second parts defining an access path for the liquid through the walls of the first and second parts toward the catalysis chamber in the open position of the catalytic system. Thus, the access of the liquid into the catalysis chamber is facilitated and an optimal exchange through convection of the liquid with the catalyst can occur. According to one variant, said walls of the first and second parts can extend transversely to the axis of deployment of the piston. According to another variant, the first and second parts are rotationally movable relative to each other between the open and closed positions. The first and second parts can comprise hollow and rotationally cylindrical tubular portions with an axis coincident with the axis around which the rotation is performed, and the wall of the first part, respectively of the second part, comprising said plurality of openings is the lateral wall of the respective cylindrical portion.

The apparatus according to the invention can also comprise a membrane that is impermeable to the liquid and is permeable to the fluid and is disposed in the enclosure so as to separate the internal space into a space containing the liquid and a space containing the generated gas. Furthermore, the apparatus can comprise a filter, mounted on the discharge opening, for example, that is configured to purify the generated gas.

Furthermore, the invention relates to a method for generating a gas, in which an apparatus according to the invention is provided, with the internal space of the enclosure containing a liquid capable of generating the gas through contact with a catalyst, the catalysis chamber of the catalytic system containing said catalyst, the method being implemented according to a control mode, called regulation mode, configured by means of first and second regulation parameters, the method comprising steps involving measuring a quantity to be regulated and commanding the actuator in order to place the catalytic system in the open position, respectively in the closed position, when the quantity to be regulated is less than, respectively greater than, the first regulation parameter, respectively the second regulation parameter.

In a particularly preferred manner:
the gas is dihydrogen;
the liquid is an aqueous solution comprising a hydride, preferably selected from sodium borohydride, potassium borohydri de, magnesium borohydride, calcium borohydride, lithium borohydride, aluminum lithium hydride, magnesium hydride, aluminum sodium hydride and the mixtures thereof, and
the catalyst is adapted to catalyze the hydrolysis reaction of the aqueous solution, and is preferably selected from platinum, ruthenium, nickel, cobalt and the mixtures thereof.

Furthermore, the liquid can comprise an alkaline agent, preferably selected from NaOH, KOH and the mixtures thereof. This thus limits the spontaneous decomposition of the hydride. When the catalytic system is in the closed position, any increase in the pressure of the gas inside the enclosure is thus limited. When the catalytic system is in the open position, this thus ensures that the decomposition of the hydride mainly results from its catalyzed hydrolysis.

Furthermore, the method according to the invention is such that the quantity to be regulated can be selected from the gas pressure inside the internal space, the pressure of the gas in a machine, preferably a fuel cell, with which the apparatus is in fluid communication, the generated gas flow rate and a temperature, for example, the temperature of the liquid or the temperature of the catalyst or the temperature of the environment of the apparatus, and the first and second regulation parameters are minimum and maximum values, respectively, of the quantity to be regulated.

Preferably, the quantity to be regulated is the gas pressure in the internal space or the pressure of the gas in a machine, preferably a fuel cell, with which the apparatus is in fluid communication, and the first and second regulation parameters are minimum and maximum pressure regulation pressures.

Preferably, according to the regulation mode, the number of cycles, each established by the arrangement of the catalytic system in a first position, then in a second position, preferably each established by opening and closing the catalytic system, can be between 1 and 10,000. The duration of a cycle can be between 1 second and 10 hours.

In particular, the method comprises a plurality of cycles and the minimum regulation pressure and/or the maximum regulation pressure can be modified between two successive, even consecutive, cycles.

For example, the minimum regulation pressure defined for a second successive, even consecutive, cycle following a first cycle can be less than the regulation pressure defined for the first cycle, and/or the maximum regulation pressure defined for said second successive cycle can be greater than the regulation pressure defined for the first cycle.

As a variant, the minimum regulation pressure defined for a second successive, even consecutive, cycle following a first cycle can be greater than the regulation pressure defined for the first cycle, and/or the maximum regulation pressure defined for said second successive cycle can be less than the regulation pressure defined for the first cycle.

In particular, the minimum and maximum regulation pressures defined for a second successive, even consecutive, cycle following a first cycle can be modified so that the arithmetic mean of said minimum and maximum regulation pressures for said second cycle is equal to the arithmetic mean of said minimum and maximum regulation pressures for said first cycle.

In one variant, the minimum and maximum regulation pressures defined for a second successive, even consecutive, cycle following a first cycle can be such that the difference between the maximum regulation pressure and the minimum regulation pressure for said second cycle is equal to the difference between the maximum regulation pressure and the minimum regulation pressure for said first cycle, and preferably, the arithmetic mean of said minimum and maximum regulation pressures for said second cycle is different, in particular greater than or less than, the arithmetic mean of said minimum and maximum regulation pressures for said first cycle.

Furthermore, according to a preferred embodiment:
at least one quantity, preferably several quantities, to be controlled is/are measured;
the quantity to be controlled is analyzed, particularly by comparing it with at least one control parameter; and
depending on the result of the analysis,
the method ceases to be controlled according to the regulation mode, then the method is controlled according to a specific control mode different from the regulation mode.

Preferably:
the quantities to be controlled are the temperature of the liquid and/or the temperature of the environment of the apparatus and/or the temperature of the catalyst, and the control parameters respectively are a minimum control temperature of the liquid and/or a minimum control temperature of the environment and/or a minimum control temperature of the catalyst;
an analysis is started that involves verifying whether, during an analysis duration, preferably between 0.1 and 2 seconds, the temperature of the liquid and/or the temperature of the environment of the apparatus and/or the temperature of the catalyst are respectively less than the minimum control temperature of the liquid and/or a minimum control temperature of the environment and/or the minimum control temperature of the catalyst and, if this is the case,
the method ceases to be controlled according to the regulation mode, then the method is controlled according to a cold control mode, in which:
   i) optionally, the actuator is commanded so as to place the catalytic system in the open position, preferably for a duration of between 1 second and 10 seconds; then
   ii) the actuator is commanded so as to place and hold the catalytic system in the closed position as long as the pressure of the gas in the enclosure is less than a maximum setpoint pressure, which preferably is greater than or equal to the maximum regulation pressure;
   iii) the actuator is commanded so as to place and hold the catalytic system in the open position and the enclosure is opened so that the generated gas is discharged from the enclosure; and
      if, during step iii) the measured gas pressure becomes less than, then greater than a minimum setpoint pressure, which is preferably less than or equal to the minimum regulation pressure, the method ceases to be controlled according to the cold control mode and, preferably, the method is controlled according to the regulation mode;
      otherwise steps i) and ii) are performed.

Preferably, the minimum control temperature of the liquid and/or the minimum control temperature of the environment and/or the minimum control temperature of the catalyst are equal to −10° C., even equal to −20° C.

In this way, by placing the liquid in the catalysis chamber, then placing the catalytic system in the closed position in step ii), it promotes the generation of gas through the effect of containing the liquid and the catalyst in the catalysis chamber isolated from the enclosure. Since the gas generation reaction is exothermic, the temperature of the catalyst increases, which makes the catalyst more reactive for the gas generation reaction during subsequent cycles of successive opening and closing in regulation mode, which allows a setpoint flow rate to be achieved more quickly. Since the catalytic system is placed in the closed configuration in step ii) of the cold control mode, the liquid located in the enclosure cannot enter the catalysis chamber and the generation of gas stops when the reagents of the liquid previously trapped in the catalysis chamber are consumed.

In one embodiment, the method comprises a step of conveying the gas generated by the apparatus outside the enclosure, and preferably inside an anode chamber of a fuel cell. The pressure of the gas then can be measured in said anode chamber. Thus, the amount of gas generated by the apparatus is adapted to the operating conditions of the fuel cell.

Finally, the invention relates to an electric energy production device, the device comprising:
a fuel cell configured to generate an electric current through oxidation of a gas;
a gas generation apparatus according to the invention, in fluid communication with the fuel cell and configured to supply the fuel cell with said gas.

The fuel cell preferably comprises an oxidation unit comprising a stack successively formed by an anode, an electrolytic membrane and a cathode, the oxidation unit being configured to generate an electric current through oxidation of the gas. The fuel cell preferably defines an anode chamber for supplying the anode with gas.

The device preferably comprises a distribution component linking the apparatus and the fuel cell in fluid communication. Preferably, the distribution component is fixed on the discharge opening of the apparatus and emerges into the anode chamber of the fuel cell.

In one embodiment, the measurement unit can be adapted to measure the pressure of the gas in the anode chamber. Preferably, the measurement unit is disposed in the anode chamber. Thus, the opening and the closing of the catalytic system are easily controlled so as to optimize safe operation of the fuel cell.

Furthermore, the command unit can be configured to send a start-up signal and/or a shutdown signal intended for the fuel cell, which is configured to receive the start-up signal and/or the shutdown signal, respectively, and to be placed in energy generation mode and/or in inactive mode.

Further features, variants and advantages of the invention will become more clearly apparent upon reading the following detailed description and examples, which are provided by way of a non-limiting illustration, and with reference to the accompanying drawings, in which:

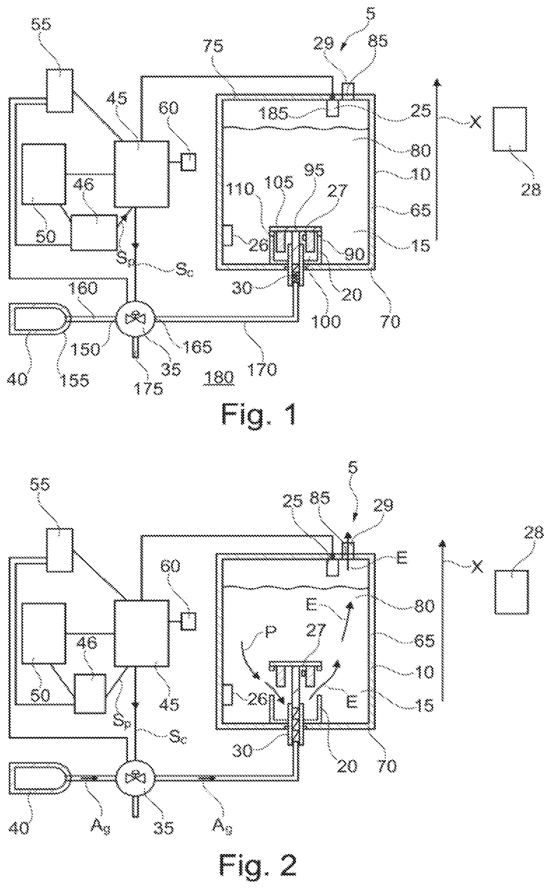

FIGS. 1 to 3 schematically show an apparatus according to various embodiments of the invention;

FIGS. 4 to 6 show enclosures and catalytic systems of apparatus according to various embodiments of the invention viewed as a longitudinal section view;

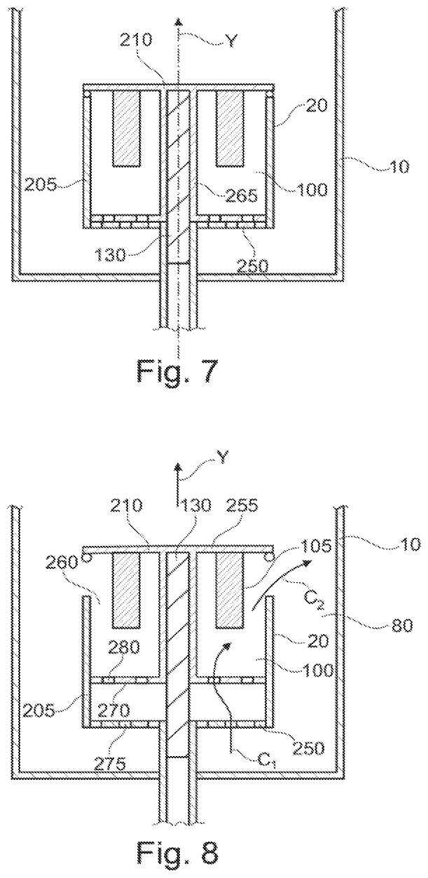

FIGS. 7 and 8, on the one hand, and 9 and 10, on the other hand, show enclosures and catalytic systems of apparatus according to various embodiments of the invention viewed as a longitudinal section view in the closed and open position, respectively;

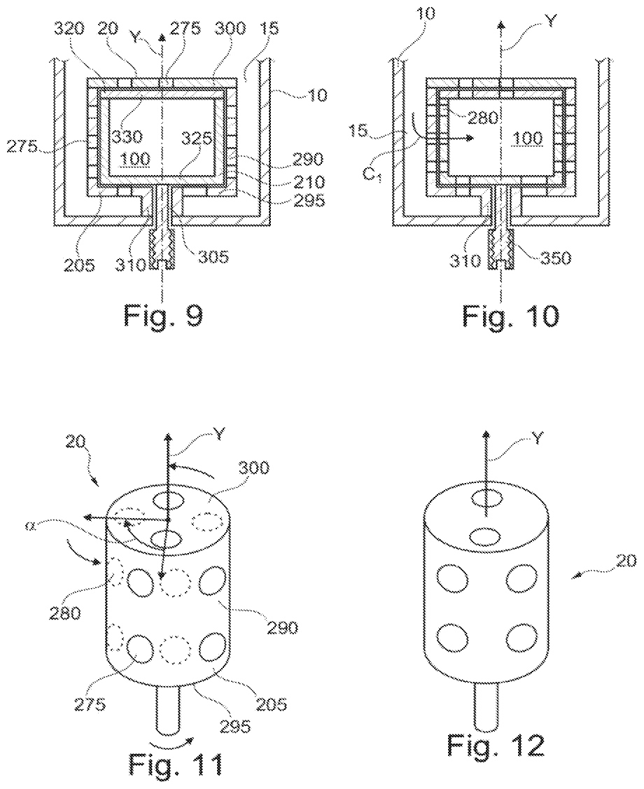

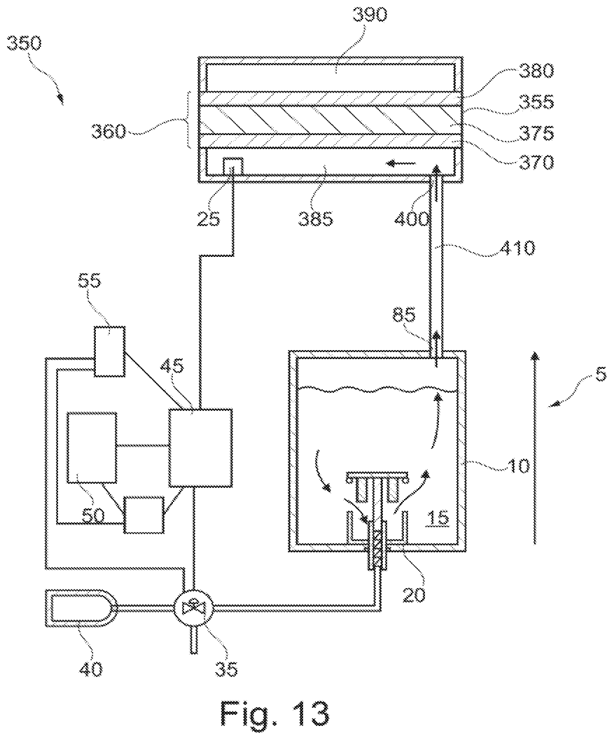

FIGS. 11 and 12 show the catalytic system of FIGS. 9 and 10, respectively, as a perspective view;

FIG. 13 shows a device according to one embodiment of the invention;

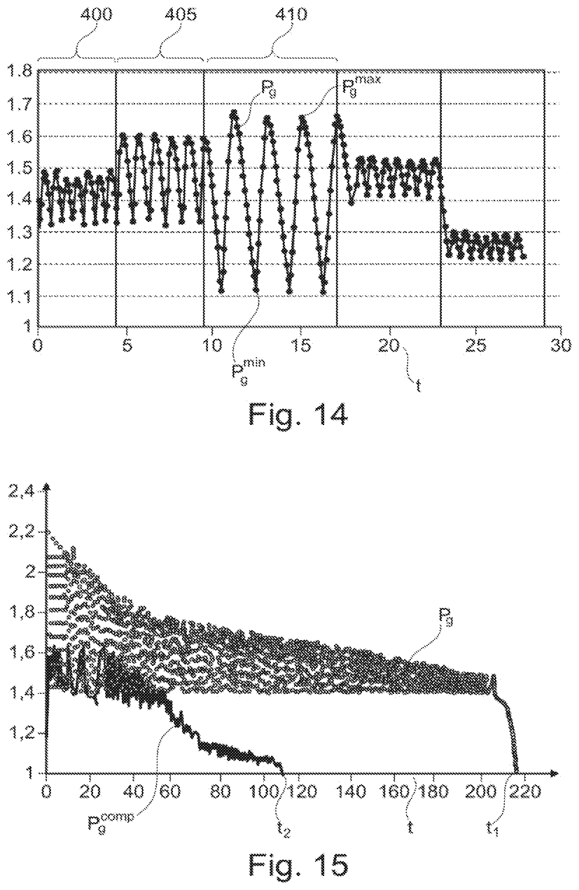

FIG. 14 is a graph showing the pressure variation of the gas inside the enclosure during the implementation of the method according to the invention;

FIG. 15 is a graph showing the pressure variation over time during the implementation of the method according to the invention and of a method of the prior art; and

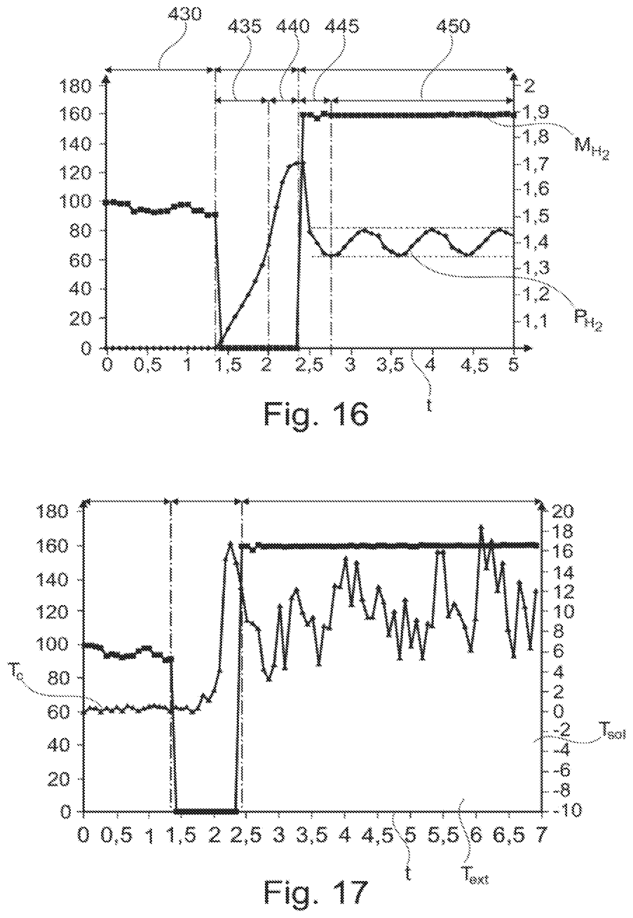

FIGS. 16 and 17 shows the pressure variations in the enclosure, the generated gas flow rate, the temperature of the catalyst and the temperature of the environment during the implementation of the method.

Throughout the figures, the scales and proportions of the various components and units forming the apparatus and the device are not necessarily followed. Furthermore, for the sake of clarity, components can be shown as not being in contact with one another whilst they are in practice. Different reference signs can denote the same component.

FIG. 1 shows a first embodiment of the apparatus according to the invention.

The apparatus 5 comprises:
an enclosure 10 defining an internal volume 15, in which a catalytic system 20 and a pressure measurement unit 25, temperature measurement units 26, 27 and 28, and a generated gas flow rate measurement unit 29 are disposed;
an actuator in the form of a pneumatic ram 30 fixed on the enclosure and on the catalytic system;
a command valve 35 in fluid communication, on the one hand, with the ram, in order to deliver a pressurized fluid to the ram, and, on the other hand, with a fluid supply component 40;
a command unit 45 electrically connected to the command valve and to the pressure measurement unit;
a control unit 46 electrically connected to the command unit; and
a reader module 50 electrically connected to the command unit and to the control unit.

The apparatus further comprises a battery 55 for electrically powering the command unit, the control unit, the reader module and the command valve.

Furthermore, the command unit can comprise a switch 60, so that when the switch is placed in the off position, the command unit is not electrically powered. Preferably then, the catalytic system is placed in the closed position. When the switch is placed in the on position, the command unit is electrically powered.

The enclosure comprises a side wall 65, which extends in a longitudinal direction X, a lower wall 70 defining a base of the enclosure when the longitudinal direction is parallel to the direction of gravity, and an upper wall, having a gas discharge opening. In one variant, the discharge opening can be surmounted by a valve, preferably a flow control valve. Furthermore, the discharge opening can be surmounted by an overpressure valve, not shown, for discharging the gas when the pressure of the gas in the internal space is greater than a threshold pressure.

The internal space 15 can contain an aqueous hydride solution 80. Other liquids adapted to form a gas by coming into contact with a catalyst can be contained in the internal space.

The pressure measurement unit 25 is disposed in the internal space of the enclosure. In the example of FIG. 1, it is disposed in the vicinity of a discharge opening 85 provided in the upper wall of the enclosure. Other arrangements nevertheless can be contemplated.

The catalytic system 20 comprises a container 90 disposed, preferably rigidly fixed, on the lower wall of the container and a cover 95.

The container and the cover together define a catalysis chamber 100, in which a catalyst 105 is housed for the hydrolysis of the aqueous hydride solution.

In the example of FIG. 1, the cover is closed on the container and comprises a gasket seal 110 to seal against the liquid, so that the catalysis chamber is isolated from the internal space 15 of the container. Thus, in the closed position of the apparatus of FIG. 1, the liquid contained in the internal space cannot enter the catalysis chamber.

The catalyst 105 is fixed on the cover and is in the form of a hollow tube. As will be described hereafter, other arrangements of the catalyst in the catalytic system and other forms can be contemplated.

Furthermore, holes 115, 120 are respectively provided in the bottom wall of the container of the catalytic system and in the lower wall of the enclosure. They pass through the respective thicknesses of said walls from one end to the other and are fixed facing each other. Preferably, said holes 115 and 120 have identical shapes.

The ram 30 is disposed in said holes and is rigidly fixed relative to the enclosure. The ram comprises a cylindrical body 125 and a piston 130 housed in the cylindrical body and movable relative to the cylindrical body. In the example of FIG. 1, the hole 115 provided in the lower wall of the enclosure is tapped and the cylindrical body is fixed on the enclosure by screwing the cylindrical body into the tapped hole 115. The ram further comprises a return component 135 in the form of a helical spring fixed at its opposite ends on the body and on the piston, which provides a return function. In one variant, the ram can be of the “double acting” type, provided with two chambers each supplied with a compressible fluid, with one of the chambers providing the return function. In the closed position of the apparatus shown in FIG. 1, the spring is in an equilibrium position, in which it does not exert a return force on the piston.

The ram defines a ram chamber 140 for containing a pressurized fluid so as to move the piston between the closed position shown in FIG. 1 and an open position shown in FIG. 2. The end 145 of the piston opposite to that which faces the ram chamber is fixed on the cover. Thus, the cover is translationally movable relative to the enclosure and to the container between the open and closed positions.

With respect to the command valve 35, it has an inlet 150 connected to the fluid supply component, which in the example of FIG. 1 is a cartridge 155 of pressurized pneumatic fluid, by means of an inlet pipe 160. The command valve has a supply outlet 165 connected to the ram chamber by means of a pipe 170. It further comprises a purge outlet 175, emerging into the environment 180 outside the apparatus where the pressure is lower than the pressure in the cartridge, preferably where the pressure is atmospheric. The valve is electrically connected to the command unit by means of a cable, which command unit is configured to send an electric command signal Sc to the command valve, and the command valve is configured to receive said signal.

The command signal can be a signal for commanding the opening of the command valve. When the command valve receives such an opening command signal, it is placed in a configuration in which the purge outlet 175 is closed, and the pressurized fluid cartridge is placed in fluid communication with the ram chamber. The fluid can then flow from the cartridge through the supply inlet 150 and outlet 165 of the command valve, up to the ram chamber, as shown by means of the arrows A_{g}. Thus, the piston 130 can be moved from the closed position to the open position, or held in the open position, as shown in FIG. 2.

The command signal can be a closure command signal. When the command valve receives a closure command signal it is placed in a configuration in which the inlet 150 of the command valve is closed and in which the purge outlet 175 and the supply outlet 165 are open and in fluid communication. The fluid contained in the ram chamber flows into the supply pipe to the outside of the apparatus, through the purge outlet. With the pressure decreasing in the ram chamber, the piston then moves, under the effect of the return force of the spring or of a back pressure in the variant whereby the ram is of the “double acting” type, so as to place the catalytic system in the closed position.

Preferably, the command valve comprises an electric activation component, not shown, for placing the valve in any of the configurations described in the previous two paragraphs, depending on the received electric signal. The electric activation component is electrically connected to the battery.

The electric signal sent by the command unit to the command valve depends on the result, obtained by the command unit, of the comparison between the minimum regulation pressure and/or the maximum regulation pressure, on the one hand, and the gas pressure measured by the pressure measurement unit, on the other hand.

In the example of FIG. 1, the pressure measurement unit 25 comprises a pressure sensor 185 for measuring the gas pressure in the enclosure. According to a regulation control mode implemented by the command unit, the pressure measurement unit sends the pressure of the gas that it measures to the command unit, which receives the pressure and compares it with the minimum and maximum regulation pressures. When the gas pressure is less than the minimum regulation pressure, the command unit transmits a command signal to open the command valve so as to open the regulation system. As shown in FIG. 2 using the arrow P, the liquid can then enter the catalysis chamber and come into contact with the catalyst, so that the gas is generated through a reaction between the liquid and the catalyst. The gas then flows under the effect of the Archimedes thrust through the liquid in the enclosure and is discharged through the gas discharge opening 85, as shown by the arrows E, for example, toward the anode chamber of a fuel cell 355, as shown in FIG. 13.

The generation of gas inside the enclosure results in an increase in the pressure of the gas in the enclosure if said gas is not fully consumed, for example, by a fuel cell as shown in FIG. 13. When the pressure of the gas is greater than the maximum regulation pressure, the command unit transmits a closure command signal to the command valve, so as to place the catalytic system in the closed position. The generation of gas is then stopped. The gas remaining in the enclosure after placing the apparatus in the closed position is discharged from the enclosure if it is consumed, by a fuel cell, for example, so that the gas pressure in the enclosure decreases, until it drops below the minimum regulation pressure. According to the regulation mode, a new gas generation cycle comprising opening the catalytic system as previously described then can be conducted.

Furthermore, the reader module 50 allows the minimum and/or maximum regulation pressure to be regulated, which pressures are, for example, stored in a storage medium in the form of a file. The reader module reads and sends the value of the minimum regulation pressure and/or the value of the maximum regulation pressure to the command unit, which receives the value in order to compare it with the pressure measured by the gas pressure measurement unit, prior to sending a command signal to the command valve.

With respect to the control unit 46, even though it is not shown for the sake of clarity, it is electrically connected to the temperature measurement units 26, 27 and 28, to the generated gas flow rate measurement unit 29, and is electrically powered by the battery 55. The temperature measurement unit 26 is disposed in the internal space so as to measure the temperature of the liquid 80. The temperature measurement unit 27 is disposed in the catalysis chamber in contact with the catalyst 105 in order to measure the temperature. The temperature measurement unit 28 is disposed outside the apparatus to measure the temperature of the environment of the apparatus. The generated gas flow rate measurement unit 29 is disposed on the discharge opening 85.

In the example of FIGS. 1 and 2, each of the measurement units 26 to 28 is configured to send the value of the temperature that it measures to the control unit, which is configured to receive and to control the value. Depending on the regulation mode, the control unit checks whether the temperature of the liquid, the temperature of the catalyst and the temperature of the environment of the apparatus are less than respective minimum control temperatures, for an analysis duration, for example, of 5 seconds. If this is the case, it sends a control signal Sp to the command unit for the command unit to execute a cold control mode.

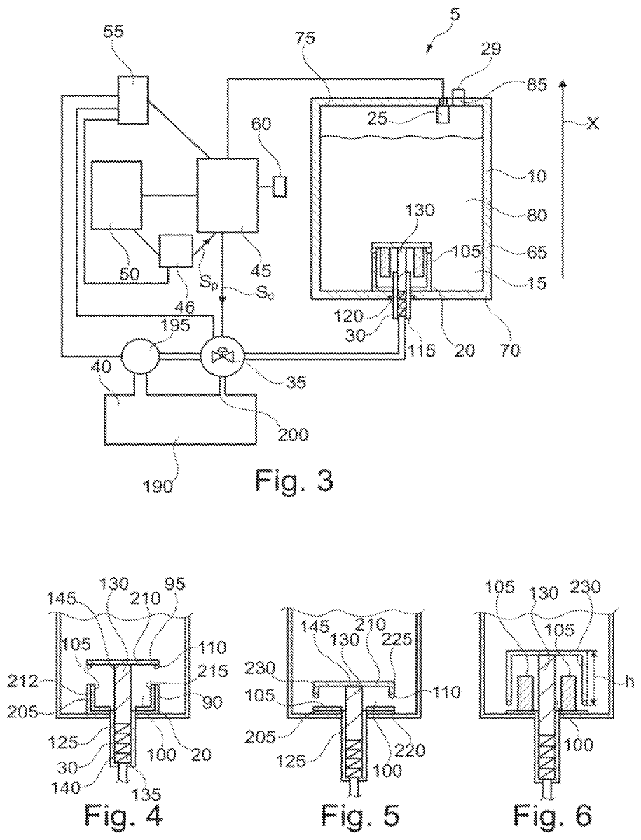

The apparatus shown in FIG. 3 differs from that shown in FIGS. 1 and 2 in that it comprises, instead of the fluid cartridge, a fluid supply component 40 comprising a tank 190 for containing the fluid and an electric compressor 195, powered by the battery 55, for compressing the fluid originating from the tank and delivering said fluid to the command valve. In the example of FIG. 3, the fluid is a gas and the ram is pneumatic. In one variant, the fluid is a liquid, for example, an oil and the ram is hydraulic. The compressor 195 is then replaced by a pump.

Furthermore, the tank comprises an inlet opening 200 in fluid communication with the purge outlet of the command valve. Thus, when the ram is purged of the fluid after receiving a closure command signal, the purged fluid is introduced into the tank. Thus, the fluid supply component, the command valve and the ram form a closed circuit for the fluid.

As previously stated, the catalytic system comprises first 205 and second 210 parts that together define a catalysis chamber for containing the catalyst. FIGS. 4 to 6 show various examples of catalytic systems, as well as arrangements of the catalyst inside the catalytic system.

The catalytic system of FIG. 4 differs from that shown in FIG. 1 in that the internal face 212 of the side wall is covered with a coating 215 formed by the catalyst. Such a catalytic system allows the amount of catalyst to be limited whilst having an exchange surface between the catalyst and the liquid for effectively generating the gas.

The catalytic system of FIG. 5 differs from the catalytic system of FIG. 4 in that the first part 205 is in the form of a plate and the second part 210 is in the form of a bell. The face of the first part facing the second part is covered by a coating 220 formed from the catalyst. The second part has an upper wall 225 fixed to the piston of the ram and a side wall 230 extending in the longitudinal direction of the ram. In one variant, the side wall can be oriented obliquely relative to the longitudinal direction of the ram. The edge of the longitudinal wall of the second part is surmounted by a sealing gasket 110, which presses against the edge of the first part in the closed position to isolate the liquid from the catalyst. The catalytic system of FIG. 5 is easy to manufacture. In particular, the coating can be easily formed on the plate forming the first part at a lower cost. Furthermore, by limiting the height of the walls of the second part, a compact catalytic system thus can be manufactured.

The catalytic system of FIG. 6 differs from the catalytic system of FIG. 5 in that the height h of the side wall 230 is higher. Thus, the volume of the catalysis chamber 100 of the catalytic system of FIG. 6 is greater than that shown in FIG. 5. Such a system is better adapted than that of FIG. 5 in the event that a significant volume of catalyst is required to implement gas generation.

FIGS. 7 and 8 show another variant of a catalytic system of an apparatus according to the invention in a closed and open position, respectively.

The catalytic system 20 shown in FIGS. 7 and 8 differs from the catalytic system of FIG. 1 in that the lower wall 250 of the first part 205 is disposed at a distance from the container 10. Furthermore, the second part 210 has an upper wall 255 in the form of a plate for closing the upper opening 260 of the first part. A tubular portion 265 projects from the upper wall of the second part, in which the piston 130 of the ram is partially housed. Preferably, as is shown, the piston and the tubular portion are of matching shape. At the end thereof that is opposite that which is closed by the cover, the second part has a lower wall 270 extending transversely to the longitudinal direction Y of the ram.

The lower walls 250, 270 of the first and second parts are each perforated by at least one window, preferably several windows, passing through the thickness of each of said walls. The openings 275, 280 of the lower walls of the first and second parts are disposed so that, in the closed position, as shown in FIG. 7, said lower walls of the first and second parts form a liquid-impermeable assembly, isolating the catalysis chamber from the enclosure, and in the open position, as shown in FIG. 8, they define a fluid access path, shown by the arrow C₁, between the internal space 15 of the enclosure and the catalysis chamber 100 through said lower walls of the first and second parts. Thus, in the open position, the catalytic system defines a fluid access path between the upper wall of the second part and the side wall of the first part, shown by the arrow C₂, and at least one access path between the lower walls of the first and second parts, shown by the arrow C₁. The convection of the liquid inside the catalysis chamber is thus improved, which optimizes the yield of the gas generation reaction. In the example of FIGS. 7 and 8, the transition from the open position to the closed position is performed through a translation movement of the second part relative to the first part.

FIGS. 9 to 11 show another variant of an apparatus according to the invention, in which the first 205 and second 210 parts are rotationally movable relative to each other between the open and closed positions around an axis Y.

The first part has a general shape of a rotationally cylindrical and hollow tubular portion 290 and having opposite ends respectively closed by a lower wall 295 and by an upper wall 300 extending in directions transverse to the axis of rotation of the tubular portion. The axis of rotation of the cylindrical tubular portion is parallel to the axis Y.

Preferably, the upper wall 300 is detachable and is fixed, in particular by screwing, on the tubular portion 290.

The lower wall 295 of the first part has a recess 305 passing through the thickness of the lower wall and from which a spacer 310 projects. The spacer keeps the tubular portion 290 of the first part at a distance from the enclosure 10. The spacer is in the form of a hollow and cylindrical tube, preferably rotational, coaxial to the tubular portion of the first part.

Furthermore, the lower, upper and side walls of the first part comprise at least one window 275, preferably several windows, each passing through the thickness of said walls. In one variant, at least one of said walls of the first part may not have windows.

The second part 210 has a general shape of a rotationally cylindrical hollow tube 320 surmounted at its opposite ends by a lower wall 325 and an upper wall 330, which is preferably detachable. The second part thus defines a catalysis chamber 100 for the catalyst.

Furthermore, the lower, upper and side walls of the second part comprise at least one window 280, preferably several windows, each passing through the thickness of said walls. In one variant, at least one of said walls of the second part may not have windows.

The second part is at least partially, even completely, accommodated in the internal space of the tubular portion of the first part, as shown in FIG. 9. The first and second parts have matching shapes and are coaxial.

The windows of the lower, side and upper walls of the first and second parts are respectively disposed so that, in the closed position, as shown in FIGS. 9 and 11, said lower walls of the first and second parts obstruct the windows of the second and first parts, respectively, and form a liquid-impermeable assembly, isolating the catalysis chamber 100 from the internal space 15 of the enclosure, and in the open position, as shown in FIGS. 10 and 12, they define a fluid access path, shown by the arrow C₁, between the catalysis chamber and the internal space of the enclosure through said lower, side and upper walls of the first and second parts. In FIG. 11, the windows of the second part are shown as dashed lines in order to indicate their angular position relative to the windows of the first part.

The transition from the closed position to the open position is performed by rotating, by an angle a, the second part relative to the first part about the axis Y. To this end, the second part is fixed on a shaft of a stepper motor 350 engaged in the spacer. The stepper motor comprises a stator and a rotor rotationally movable relative to each other about the axis Y. The stepper motor is electrically powered by the battery and is connected to the command unit. It is configured to drive the second part relative to the first part in the open position or the closed position upon receipt of a signal originating from the control unit.

FIG. 13 shows a device 350 according to the invention, comprising a fuel cell 355 supplied with dihydrogen by an apparatus 5 according to the invention.

The fuel cell comprises an oxidation unit 360 including a stack formed by an anode 370, an electrolytic membrane 375 and a cathode 380. It also defines an anode chamber 385 for distributing the dihydrogen to the anode, and a cathode chamber 390, for distributing dioxygen to the cathode.

The anode chamber further comprises an inlet orifice 400 for the supply of dihydrogen, which orifice is connected to the discharge opening 85 of the apparatus by means of a hollow conveyance tube 410.

The apparatus shown in FIG. 13 is identical to that described in FIG. 1, except that the pressure measurement unit 25 is disposed in the anode chamber 385 of the fuel cell. In another variant, not shown, the pressure measurement unit 25 can be disposed in the hollow tube 410.

Thus, during operation, the generation of dihydrogen by the apparatus is adapted as a function of the dihydrogen requirement of the fuel cell.

With respect to the method according to the invention, it comprises at least one cycle, preferably several cycles, made up of steps a) to c).

FIG. 14 shows the evolution of the gas pressure P_{g} inside an enclosure of an apparatus according to the invention, as is particularly described in FIGS. 1 and 2, as a function of the time t for implementing the method. As can be seen, the gas pressure changes between minimum P_{g}^{min} and P_{g}^{max} maximum values, which correspond to the minimum and maximum regulation pressures, respectively. For example, during the first period 400 for implementing the method (between t=0 and t=4), the minimum regulation pressure equals 1.3 bar and the maximum regulation pressure equals 1.5 bar. Starting from t=4, in a second period 405 for implementing the method, the user modifies the maximum regulation pressure, by means of the regulation unit, to a value of 1.6 bar. Starting from t=9, in a third period 410 for implementing the method, the maximum and minimum regulation pressures are simultaneously modified, respectively increased to 1.7 bar and decreased to 1.1 bar. Thus, the average pressure during the first 400 and third 405 periods is identical, equal to 1.4 bar. For example, for an identical average pressure, an increase in the maximum regulation pressure and a decrease in the minimum regulation pressure results in a reduction in the number of opening/closing cycles of the catalytic system, which reduces the compressible fluid consumption and the energy consumption for generating the gas. A reduction in the amplitude around the average pressure, by decreasing the maximum regulation pressure and increasing the minimum regulation pressure enables better adaptation to the operating requirements of a fuel cell. It also allows the gas generation apparatus to respond more quickly and easily to peaks in the setpoint flow rate imposed by a fuel cell to which the apparatus is connected. Regulating the minimum and maximum regulation pressures thus allows the user of the device to adapt the gas generation to the specifics of the application for which the gas is intended.

### EXAMPLES

The invention is illustrated by means of the following non-limiting examples.

### Example 1

Gas is generated by means of an apparatus as shown in FIG. 1. To this end, the catalytic system comprises, inside the catalysis chamber, 1 gram of cobalt, and the internal space of the enclosure, with a capacity of 0.6 1, contains 0.5 1 of a sodium borohydride solution. The initial temperatures of the catalyst and of the liquid solution are both equal to 25° C.

The apparatus is connected to a fuel cell, which it supplies with generated dihydrogen.

The minimum regulation pressure is set to 1.4 bar and the maximum regulation pressure is set to 1.5 bar.

FIG. 15 shows the evolution of the gas pressure P_{g} in the enclosure as a function of the time t for implementing the method.

At the instant tₒ=0, the catalytic system is placed in the open position. The gas generation begins and the generated gas setpoint flow rate is reached (value of 1,000 ml/min) from the first cycle for implementing the method. As can be seen in FIG. 15, the gas pressure Pg in the enclosure is, in the initial instants of the generation of dihydrogen, greater than 2 bar, whereas the maximum regulation pressure is 1.5 bar. This phenomenon is explained by the inventors as resulting from a catalytic chamber volume that is not optimized, which is too big compared to the volume of the catalyst. Over time, the hydride content of the solution decreases, such that the volume of solution captured in the catalysis chamber during each closure causes increasingly less gas to be generated. With the gas consumption by the fuel cell being constant, the gas pressure in the enclosure thus exceeds the maximum imposed regulation pressure less and less often. The generation of gas thus continues until the instantaneous amount of generated gas is less than the instantaneous amount of gas consumed by the fuel cell to which the apparatus is connected (instant t₁=220 min), as shown in FIG. 15.

Thus, the mass hydrogen yield, defined as the ratio between the generated hydrogen mass and the total mass of solution of the method according to the invention, is 3.6%.

### Comparative Example

Gas is generated by means of the enclosure of the device of the apparatus shown in FIG. 1. The catalytic system, in the form of a buoy disclosed in WO 2012/003112 A1, is used instead of the catalytic system according to the invention. The same amounts of cobalt and of sodium borohydride solution are used as in example 1.

FIG. 15 shows the evolution of the gas pressure P_{g}^{comp} in the enclosure as a function of the time t for implementing the method.

At the instant tₒ=0, the catalytic system is placed in the open position. The gas generation begins and the generated gas setpoint flow rate is immediately reached (value of 1,000 ml/min).

The generation of gas at the setpoint flow rate thus continues until the pressure in the enclosure reaches 1 bar at t₂=110 min. From this instant, the pressure in the enclosure becomes equal to the atmospheric pressure. The apparatus of the prior art can no longer produce a sufficient amount of gas to guarantee the setpoint flow rate, since the concentration of reagents is too low in relation to the accessibility of the catalyst.

Thus, the mass yield of the method of the prior art is 1.8%.

### Example 3

A device as described in FIG. 13 is provided, except that the pressure measurement unit 25 is provided to measure the gas pressure in the internal space, as shown in FIG. 1. The method is implemented under the following conditions. The desired setpoint flow rate, regulated by a flow control valve fixed on the discharge opening of the apparatus (not shown), is set to 160 ml/min. This flow rate control valve allows the gas consumption of a fuel cell to be simulated. The apparatus is disposed in a climatic enclosure, the temperature of which is −8° C. Before opening the catalytic system, the temperature of the hydride solution is −1° C. and the temperature of the catalyst is 0° C.

The evolution of the temperatures of the catalyst Tₑ, of the aqueous hydride solution Tₛₒₗ contained in the enclosure, of the environment outside the apparatus Tₑₓₜ, as well as of the dihydrogen flow rate M_{H2} and the dihydrogen pressure P_{g} in the enclosure as a function of the time for implementing the method, are shown in FIGS. 16 and 17.

At tₒ=0, the apparatus is controlled so that the command unit executes a regulation control mode as previously described. The catalytic system is open after a command to open the piston is sent to the command valve, with the gas pressure initially being less than the minimum regulation pressure. With the temperature of the catalyst and of the aqueous hydride solution both being less than 5° C., the catalyzed hydrolysis reaction exhibits slow kinetics, such that the generated dihydrogen flow rate is approximately 100 ml/min, less than the setpoint flow rate, throughout a first period 430, up to t=1.4 min.

During the period 430, the control unit analyzes, as control quantities, the generated dihydrogen flow rate M_{H2} and the temperature of the catalyst T_{c}.

At t=1.4 min, the control unit sends a transmission, as a result of the analysis, to the effect that the flow rate is less than a setpoint flow rate set to 160 ml/min, and that the temperature of the liquid is less than a setpoint temperature set to 0° C. It then transmits a control signal intended for the command unit for implementing a cold control mode. Following the reception of the control signal, the command unit executes the cold control mode by firstly sending a closure command signal to the command valve in order to place the catalytic system in the closed position. Optionally, it can send a signal to the flow control valve to close the discharge opening in order to prevent dihydrogen from being discharged out of the enclosure. As a variant, a signal can be sent to the fuel cell so that said cell is paused during the execution of the cold control mode. The closure command signal is maintained throughout the periods referenced 435 and 440. A volume of aqueous hydride solution is thus contained in the catalysis chamber, isolated from the internal space of the enclosure. This volume of aqueous hydride solution reacts in contact with the catalyst, which leads to a generation of dihydrogen, which is discharged out of the catalytic chamber in the internal space. The dihydrogen pressure increases in the enclosure. With the hydrolysis of the aqueous hydride solution being exothermic, the temperature of the catalyst consequently increases during the periods 435 and 440 up to approximately 16° C. During the periods 435 and 440, according to the cold control mode, the control unit receives and analyzes the generated gas pressure and, optionally, the temperature of the catalyst, as quantities to be controlled. At the end of the period 440, the generated gas pressure is greater than a control parameter, namely the maximum regulation pressure of the regulation mode, set to 1.5 bar. The command unit then sends a command signal for opening the enclosure, at the start of the period 445, so that the dihydrogen is discharged and is, for example, consumed by a fuel cell PAC, thus reducing the dihydrogen pressure in the enclosure. The command unit can send, at the end of the period 445, a command signal for placing the catalytic system in the open position, as is described hereafter. For example, the transmission of the command signal for opening the enclosure can result from the reception of a signal originating from the fuel cell. During the period 445, the gas pressure decreases, with the flow control valve being open allowing the gas to escape from the enclosure. The command unit then analyzes the gas pressure and compares it to a second control parameter, which is, for example, less than the minimum pressure of the regulation mode. For example, the second control parameter is the atmospheric pressure. In the event that the gas pressure in the enclosure drops below the second control parameter, the command unit sends a closure command signal that is maintained, as during the periods 435 and 440, so as to once again heat up the catalyst. Otherwise, if the pressure increases after having reached the minimum regulation value, following the decomposition of the hydrides of the solution in contact with the catalyst, the control unit transmits a regulation mode control signal. The command unit ceases to execute the cold control mode, as is observed during the period 450.

When the dihydrogen pressure in the enclosure drops below the minimum regulation pressure, from t=2.75 min, during the period 450, the command unit sends a command signal to open the command valve. With the temperature of the catalyst having increased relative to the first period, reaching the setpoint flow rate is immediate and several cycles for opening/closing the catalytic system according to the regulation control mode are then implemented.

As is clearly apparent from the present description, the generation of gas, in particular of dihydrogen, by means of the apparatus according to the invention can be easily adapted as a function of the application for which the generated gas is intended. In particular, it allows efficient generation of dihydrogen to be initiated, which is reliable in an environment where the temperature is below 0° C., and allows the generated gas pressure profile to be adapted to the application.

Of course, the invention is not limited to the embodiments of the apparatus and of the device according to the invention, as well as to the modes for implementing the method that have been described and shown.

1. An apparatus for generating a gas, the apparatus comprising:
an enclosure defining an internal space for containing a liquid capable of generating the gas by coming into contact with a catalyst;
a catalytic system comprising first and second parts that together define a catalysis chamber for containing the catalyst,
the first and second parts being movable relative to each other, between a closed position, in which the catalysis chamber is isolated from the internal space, and an open position, in which the catalysis chamber is in fluid communication with the internal space,
so that, when the liquid and the catalyst are respectively contained in the internal space and in the catalysis chamber, in the open position, the liquid enters the catalysis chamber and the gas is generated by bringing the liquid into contact with the catalyst;
an actuator connected to the catalytic system and configured to place the catalytic system in the open position and/or in the closed position; and
a command unit for commanding the actuator.

2. The apparatus according to claim 1, wherein the actuator is a hydraulic ram or an electric ram or a pneumatic ram or an electric motor.

3. The apparatus according to claim 2, wherein, in at least one of the open and closed positions of the catalytic system, at least one part of the ram is disposed in the housing and/or the catalytic system is disposed in the internal space of the enclosure.

4. The apparatus according to claim 2, wherein the ram is hydraulic or pneumatic, the apparatus comprising a command valve connected to the command unit and to the ram, the command valve being configured to receive a command signal originating from the command unit and to deliver an amount of pressurized fluid to the ram and/or to purge the ram of said fluid, following the reception of said command signal.

5. The apparatus according to claim 4, comprising a pressurized fluid supply component in fluid communication with the command valve, and an assembly formed by a tank comprising the pneumatic fluid connected to a compressor or to a pump for compressing the fluid.

6. The apparatus according to claim 1, wherein the command unit is configured to command the actuator according to at least one control mode configured by means of at least one control parameter.

7. The apparatus according to claim 6, wherein the control mode is a regulation mode configured by means of control parameters comprising first and second regulation parameters, and the command unit is configured to receive a quantity to be regulated, and to command the actuator so as to place the catalytic system in a first position and a second position, respectively, when the quantity to be regulated is less than the first regulation parameter, and is respectively greater than the second regulation parameter.

8. The apparatus according to claim 6, comprising a control unit configured to:
receive at least one quantity to be controlled;
analyze the quantity to be controlled; and
depending on the result of the analysis:
generate a control signal according to the regulation mode or to a specific control mode different from the regulation mode; and
send the control signal to the command unit that is configured to receive said control signal and to command the actuator according to the control mode corresponding to the control signal.

9. The apparatus according to claim 1, comprising a unit for measuring a quantity selected from the gas pressure in the internal space, the pressure of the gas in a machine, with which the apparatus is in fluid communication, the generated gas flow rate and a temperature, the measurement unit being configured to send the measured quantity to the command unit and/or to the control unit.

10. The apparatus according to claim 9, wherein, depending on the control mode to be implemented by the command unit, the quantity measured by the measurement unit is a quantity to be regulated and/or a quantity to be controlled.

11. The apparatus according to claim 1, comprising the catalyst, with at least one portion of the catalyst being fixed to the first part and/or to the second part, and/or the internal space contains the liquid.

12. The apparatus according to claim 1, wherein a wall of the first part, respectively of the second part, comprises at least one window passing through the thickness of said wall, the window of the first part, respectively of the second part, being completely sealed by the second part, respectively by the first part, in the closed position of the catalytic system, and the windows of the first and second parts define an access path for the liquid through the walls of the first and second parts toward the catalysis chamber in the open position of the catalytic system.

13. A method for generating a gas, wherein an apparatus according to claim 1 is provided, the internal space of the enclosure containing a liquid capable of generating the gas through contact with a catalyst, and the catalysis chamber of the catalytic system containing said catalyst, the method being implemented according to a control mode, called regulation mode, configured by means of first and second regulation parameters, the method comprising steps involving measuring a quantity to be regulated and commanding the actuator to place the catalytic system in first and second positions, respectively, when the quantity to be regulated is less than, respectively greater than, the first regulation parameter and, respectively, the second regulation parameter.

14. The method according to claim 13, wherein the quantity to be regulated is selected from the gas pressure in the internal space, the pressure of the gas in a machine, with which the apparatus is in fluid communication, the generated gas flow rate and a temperature, and the first and second regulation parameters are respectively minimum and maximum values of the quantity to be regulated.

15. The method according to claim 14, wherein the quantity to be regulated is the gas pressure in the internal space, and the first and second regulation parameters are respectively minimum and maximum regulation pressures.

16. The method according to claim 13, wherein:
at least one quantity to be controlled is measured;
the quantity to be controlled is analyzed, in particular by comparing it with at least one control parameter; and
depending on the result of the analysis,
the method ceases to be controlled according to the regulation mode, then the method is controlled according to a specific control mode different from the regulation mode.

17. The method according to claim 16, wherein:
the quantities to be controlled are the temperature of the liquid and/or the temperature of the environment of the apparatus and/or the temperature of the catalyst, and the control parameters respectively are a minimum control temperature of the liquid and/or a minimum control temperature of the environment and/or a minimum control temperature of the catalyst;
an analysis is started that involves verifying whether, during an analysis duration, the temperature of the liquid and/or the temperature of the environment of the apparatus and/or the temperature of the catalyst are respectively less than the minimum control temperature of the liquid and/or a minimum control temperature of the environment and/or the minimum control temperature of the catalyst and, if this is the case,
the method ceases to be controlled according to the regulation mode, then the method is controlled according to a cold control mode, in which the quantity to be controlled is the pressure of the gas in the enclosure, and:
i) optionally, the actuator is commanded so as to place the catalytic system in the open position; then
ii) the actuator is commanded so as to place and hold the catalytic system in the closed position as long as the pressure of the gas in the enclosure is less than a maximum setpoint pressure;
iii) the actuator is commanded so as to place and hold the catalytic system in the open position and the enclosure is opened so that the generated gas is discharged from the enclosure; and
if, during step iii) the measured gas pressure becomes less than, then greater than a minimum setpoint pressure, the method ceases to be controlled according to the cold control mode;
otherwise steps i) and ii) are performed.

18. The method according to claim 17, wherein the minimum control temperature of the liquid and/or the minimum control temperature of the environment and/or the minimum control temperature of the catalyst are equal to 5° C.

19. An electric energy production device, the device comprising:
a fuel cell configured to generate an electric current through oxidation of a gas; and
a gas generation apparatus according to claim 1, in fluid communication with the fuel cell and configured to supply the fuel cell with said gas.

20. The apparatus according to claim 1, the first and second parts being movable relative to each other by translation and/or by rotation.

21. The apparatus according to claim 4, wherein the ram is pneumatic.

22. The apparatus according to claim 5, the pressurized fluid supply component being a cartridge comprising the pressurized pneumatic fluid.

23. The apparatus according to claim 22, the cartridge being detachably connected to the command valve.

24. The method according to claim 13, the gas being dihydrogen, the liquid being an aqueous hydride solution and the catalyst being selected from platinum, cobalt, ruthenium, nickel and the alloys thereof.
